(19) United States
(12) Patent Application Publication
(10) Pub. No.: US 2022/0225386 A1
(43) Pub. Date: Jul. 14, 2022

(54) Methods For Base Station And UE COT Sharing In Mobile Communications

(71) Applicant: MediaTek Singapore Pte. Ltd., Singapore (SG)

(72) Inventor: Abdellatif Salah, Cambourne (GB)

(21) Appl. No.: 17/540,364

(22) Filed: Dec. 2, 2021

Related U.S. Application Data
(60) Provisional application No. 63/137,177, filed on Jan. 14, 2021.

(51) Int. Cl. H04W 72/12; H04W 72/04

(52) U.S. Cl. CPC H04W 72/1289; H04W 72/048; H04W 72/0446; H04W 72/042

(57) ABSTRACT

Various solutions for base station and user equipment (UE) channel occupancy time (COT) sharing in mobile communications are described. An apparatus, implementable in or as a UE, determines a channel occupancy time (COT) to rely on for an uplink (UL) transmission. The apparatus then performs the UL transmission to a network node of a wireless network during the COT, which is initiated by either the network node or the UE.

### CROSS REFERENCE TO RELATED PATENT APPLICATION(S)

The present disclosure is part of a non-provisional application claiming the priority benefit of U.S. Patent Application No. 63/137,177, filed 14 Jan. 2021, the content of which being incorporated by reference in its entirety.

### TECHNICAL FIELD

The present disclosure is generally related to mobile communications and, more particularly, to techniques for base station and user equipment (UE) channel occupancy time (COT) sharing in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5th Generation (5G) New Radio (NR), certain agreement has been made regarding COT indication for a configured uplink (UL) transmission. At present time there are several different alternatives or approaches proposed for a case when a configured UL transmission is aligned with a UE fixed frame period (FFP) boundary and ends before an idle period of that UE FFP associated to the UE. The different alternatives have been listed depending on whether or not an ongoing base station (e.g., gNB) COT is to be taken into consideration. One of the alternatives is to prioritize the sharing of a gNB-initiated COT in case that the transmission is confined within a gNB FFP before an idle period of that gNB FFP. Moreover, a UE needs some amount of time to detect any gNB downlink (DL) transmission at the start of the gNB FFP and to confirm that the gNB has initiated a COT. Thus, it is not sufficient to merely confine the UL transmission by the UE to be within a gNB FFP. Therefore, there is a need for a solution with respect to gNB and UE COT sharing in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for gNB and UE COT sharing in mobile communications.

In one aspect, a method may involve a UE determining a COT to rely on for an UL transmission. The method may also involve the UE performing the UL transmission to a network node of a wireless network during the COT, which may be initiated by either the network node or the UE.

In another aspect, a method may involve a UE receiving a cancellation signal from a network node of a wireless network during a COT. The method may also involve the UE cancelling, in response to receiving the cancellation signal, the COT as an ongoing UE-initiated COT.

In yet another aspect, an apparatus implementable in a UE may include a transceiver and a processor coupled to the transceiver. The transceiver may be configured to communicate wirelessly. The processor may determine a COT to rely on for an UL transmission. The processor may also perform the UL transmission to a network node of a wireless network during the COT, which may be initiated by either the network node or the UE.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to gNB and UE COT sharing in mobile communications s. According to the present disclosure, a number of possible solutions may be implemented separately or jointly. That is, although these possible solutions may be described below separately, two or more of these possible solutions may be implemented in one combination or another.

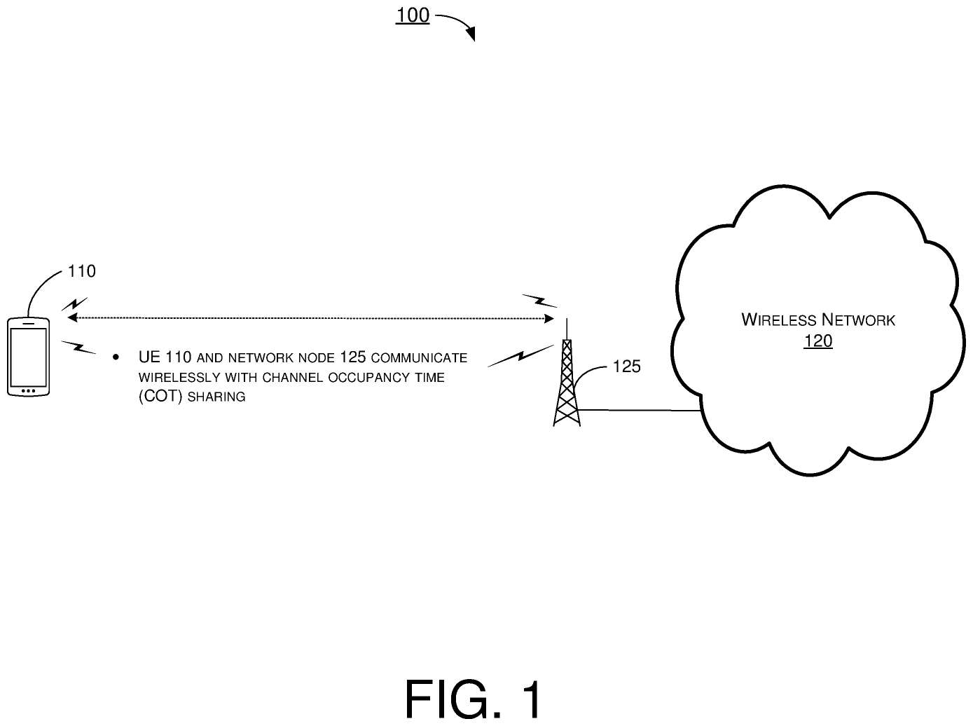

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network and/or another type of network such as a LTE network, a LTE-Advance network, a NB-IoT network, an IoT network, an IIoT network and/or an NTN). UE 110 may be in wireless communication with wireless network 120 via a base station or network node 125 (e.g., an eNB, gNB or transmit-receive point (TRP), herein interchangeably referred to as “gNB” and “base station” for simplicity). In network environment 100, UE 110, network node 125 and wireless network 120 may implement various schemes pertaining to gNB and UE COT sharing in mobile communications, as described below.

Under a first proposed scheme in accordance with the present disclosure, an UL transmission by UE 110 may be confined within a period expressed as [gNB_FFP_start+41, gNB_idle_period_start], where Δ1 denotes the time required for UE 110 to receive and detect a gNB DL transmission (e.g., from network node 125) at the start of a gNB FFP. The decision about the UE transmission may be based on the result of the DL detection at the start of the gNB FFP. However, in an event that UE 110 fails to detect the gNB DL transmission, some additional time may be required for UE 110 to perform clear channel assessment (CCA) before initiating its own COT. Thus, an additional time 42 may be defined as the time required for CCA and, accordingly, the UL transmission by UE 110 may be confined within a period expressed as [gNB_FFP_start+Δ1+Δ2, gNB_idle_period_start]. In other words, further reduction to the UL transmission by UE 110 may be made to confine the interval of the UL transmission by taking into consideration the UE processing time.

Under the proposed scheme, Δ1 and Δ2 may be defined separately or together as a single parameter Δ, where Δ=Δ1+Δ2. The lower bound of the confining interval in which the configured UL transmission by UE 110 can take place may be gNB_FFP_start+41 or gNB_FFP_start+42 or gNB_FFP_start+4. Here, Δ1 and/or Δ2 and/or Δ may be signaled by UE 110 to network node 125 as a UE capability. Multiple values of Δ1 and/or Δ2 and/or Δ may be specified (e.g., depending on the numerology, UE capability, and so on). Accordingly, the UL transmission may be confined within [gNB_FFP_start+Δ, gNB_idle_period_start], where Δ denotes a time duration required for UE processing. Moreover, in case that the transmission is confined within a gNB FFP before the idle period of that gNB FFP, and UE 110 has already determined that network node 125 has initiated that gNB FFP, then UE 110 may assume that the configured UL transmission corresponds to the gNB-initiated COT. Otherwise, UE 110 may assume that the configured UL transmission corresponds to a UE-initiated COT.

Under a second proposed scheme in accordance with the present disclosure, in a first alternative, the configured UL transmission may always rely on a UE-initiated COT. In a second alternative, the configured UL transmission may rely on a gNB-initiated COT or the UE-initiated COT. For instance, a dynamic indication (e.g., via downlink control information (DCI) signaling) or a semi-static configuration may be used by network node 125 to switch between the aforementioned two alternatives, or between relying on the UE-initiated COT and gNB-initiated COT for the configured UL transmission. Accordingly, the UL transmission relying on the UE-initiated COT may be defined as a UE capability and UE 110 may signal to network node 125 the support of this capability.

Under a third proposed scheme in accordance with the present disclosure, UE 110 may determine that network node 125 has ended the sharing of another UE COT. Under the proposed scheme, network node 125 may indicate implicitly or explicitly the end of its sharing of another UE COT. For instance, network node 125 may transmit a signal explicitly to indicate the end of its sharing of another UE COT. The signaling may be a group-common (GC) or a broadcast signaling (e.g., GC-DCI). Alternatively, the signaling may be a specific demodulation reference signal (DMRS) encoding (e.g., phase shifts). For instance, the specific DMRS may be used during the time network node 125 is sharing a UE COT. Under the proposed scheme, other UEs may determine the information implicitly. For instance, network node 125 may signal FFP parameters of the UE COT that it is sharing its COT to other UEs to determine when network node 125 is supposed to end the sharing. Under the proposed scheme, UE 110 may determine implicitly that network node 125 is sharing another UE COT in an event that network node 125 is transmitting in its own FFP idle periods.

Under a fourth proposed scheme in accordance with the present disclosure, UE 110 may determine that an UL scheduled transmission is to be transmitted using a gNB-initiated COT or a UE-initiated COT. Under the proposed scheme, UE 110 may make such a determination implicitly. For instance, in an event that network node 125 has already initiated a COT and in case that the UL transmission is scheduled in the current gNB-initiated COT and fully contained in the gNB-initiated COT, then UE 110 may rely on the gNB-initiated COT for the UL transmission. In an event that UE 110 has already initiated a COT and in case that the UL transmission is scheduled in the current UE-initiated COT and fully contained in the UE-initiated COT, then UE 110 may rely on the UE-initiated COT. In an event that time resources of the UL scheduled transmission overlap with a gNB FFP idle period, then UE 110 may rely on the UE-initiated COT. In an event that the time resources of the UL scheduled transmission overlap with a UE FFP idle period, then UE 110 may rely on the gNB-initiated COT. Otherwise, a default assumption may be used (e.g., gNB-initiated COT or UE-initiated COT). For instance, in case of alignment with a UE FFP boundary, then UE 110 may use the UE-initiated COT or else assume the gNB-initiated COT.

Under the fourth proposed scheme, UE 110 may determine whether to rely on a gNB-initiated COT or a UE-initiated COT for an UL scheduled transmission by a dynamic signaling (e.g., DCI) or a semi-static signaling (e.g., radio resource control (RRC) signaling) from network node 125. Additionally, the UL scheduled transmission relying on the UE-initiated COT may be defined as a UE capability and the support thereof may be signaled by UE 110 to network node 125. Network node 125 may or may not configure UE 110 with this functionality. Alternatively, or additionally, UE 110 may determine whether to rely on a gNB-initiated COT or a UE-initiated COT for the UL scheduled transmission implicitly from a specific DCI bit-field, a DCI format, and/or a radio network temporary identifier (RNTI). Alternatively, or additionally, the UL scheduled transmission relying on a gNB-initiated COT or a UE-initiated COT may rely on a FFP with the closest start boundary to the start of the scheduled transmission. Alternatively, or additionally, UE 110 may determine whether to rely on a gNB-initiated COT or a UE-initiated COT for the UL scheduled transmission implicitly from a time domain resource allocation of the UL scheduled transmission.

Under a fifth proposed scheme in accordance with the present disclosure, network node 125 may cancel an ongoing UE-initiated COT. For instance, an explicit signaling may be used for cancellation of an ongoing COT (e.g., DCI 2_0, DCI 2_4, and so on). Under the proposed scheme, a time duration t may be defined such that, after t from the reception of the cancellation signal, UE 110 may cancel its ongoing COT (e.g., by cancelling any ongoing transmission). The duration t may be required for UE 110 to process the cancellation signal and cancel any ongoing transmission. Under the proposed scheme, multiple values of t may be specified, and UE 110 may report to network node 125 the value(s) of t supported by UE 110. Moreover, UE 110 may acknowledge its reception of the cancellation signal to network node 125. Furthermore, cancellation of an ongoing UE-initiated COT may be defined as a UE capability or a UE feature. For instance, UE 110 may signal its support of the cancellation of an ongoing UE-initiated COT to network node 125. Correspondingly, network node 125 may configure (e.g., via RRC) or may not configure UE 110 with this feature. Additionally, UE 110 may be configured semi-statically (e.g., via RRC) or dynamically (e.g., via DCI) by network node 125 about the time instant(s) when UE 110 is to cancel an ongoing UE-initiated COT. For instance, an example time instant may be the gNB FFP boundary. Alternatively, an example time instant may be another UE FFP start boundary (e.g., that of a UE with a high-priority traffic).

Under a sixth proposed scheme in accordance with the present disclosure, UE 110 may initiate a COT within a gNB-initiated COT, and network node 125 may initiate a COT within a UE-initiated COT. For instance, UE 110 may initiate a COT within a gNB-initiated COT in case that an UL transmission would overlap with a gNB FFP idle period or in case that UE 110 has data in its buffer and hence needs a longer COT to transmit the data while sharing an ongoing gNB-initiated COT is not sufficient to transmit the UL data. Additionally, initiating a COT within a UE-initiated COT may also be useful for network node 125 to transmit and receive data from other UEs. Under the proposed scheme, UE 110 initiating a COT within a gNB-initiated COT may be supported and disabled/enabled dynamically (e.g., via DCI) or semi-statically (e.g., via RRC). Moreover, network node 125 initiating a COT within a UE-initiated COT may be supported and disabled/enabled dynamically (e.g., via DCI) or semi-statically (e.g., via RRC). Alternatively, or additionally, UE 110 initiating a COT within a gNB-initiated COT may be allowed for high-priority traffic (e.g., ultra-reliable low-latency communication (URLLC)) but not for low-priority traffic (e.g., enhanced mobile broadband (eMBB)).

Under the sixth proposed scheme, UE 110 may initiate a COT within a gNB-initiated COT in case that the UL transmission would overlap with the gNB FFP idle period of in case that UE 110 has data in its buffer and hence needs a longer COT to transmit the data while sharing an ongoing gNB-initiated COT is not sufficient to transmit the UL data. Under the proposed scheme, UE 110 initiating a COT within a gNB-initiated COT may be allowed in an event that the UL transmission (CG and/or dynamic-grant (DG)) overlaps with the gNB FFP idle period. Moreover, network node 125 initiating a COT within a UE-initiated COT may be configurable (e.g., via RRC) to UE 110. Furthermore, network node 125 initiating a COT within a UE-initiated COT may be signaled explicitly or implicitly to other UEs. For instance, it may be interpreted as an indication to some or all UEs not to initiate a COT within a given gNB-initiated COT.

### Illustrative Implementations

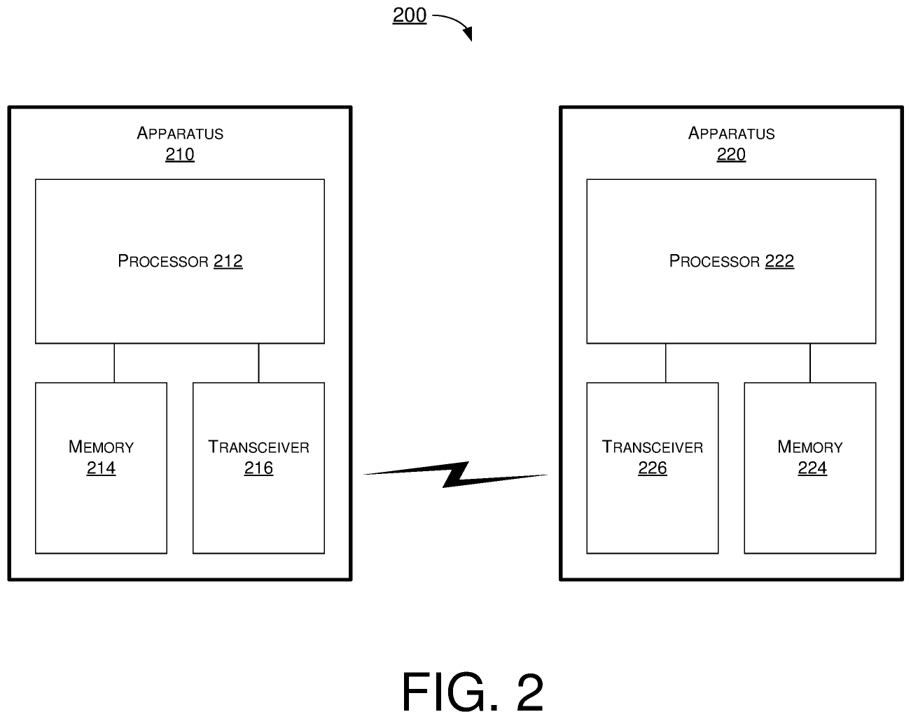

FIG. 2 illustrates an example communication system 200 having an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to gNB and UE COT sharing in mobile communications, including scenarios/schemes described above as well as processes described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including gNB and UE COT sharing in mobile communications in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., network node 125) of a communication network (e.g., wireless network 120). It is also noteworthy that, although the example implementations described below are provided in the context of mobile communications, the same may be implemented in other types of networks.

Under various proposed schemes pertaining to gNB and UE COT sharing in mobile communications in accordance with the present disclosure, with communication apparatus 210 implemented in or as UE 110 and network apparatus 220 implemented in or as network node 125 in network environment 100, processor 212 of communication apparatus 210 may determine a COT to rely on for an UL transmission. Additionally, processor 212 may perform, via transceiver 216, the UL transmission to a network node of a wireless network (e.g., apparatus 220 as network node 125 of wireless network 120) during the COT, which may be initiated by either the network node or the UE (e.g., the COT being either a gNB-initiated COT or a UE-initiated COT).

In some implementations, in determining the COT, processor 212 may be dynamically configured by the network node by: (a) receiving, via transceiver 216, a DCI signal from the network node; and (b) determining whether the COT is initiated by the UE or by the network node (e.g., gNB) based on the DCI signal.

In some implementations, in determining the COT, processor 212 may be semi-statically configured by the network node by: (a) receiving, via transceiver 216, an RRC signal from the network node; and (b) determining whether the COT is initiated by the UE or by the network node (e.g., gNB) based on the RRC signal.

In some implementations, an interval of the UL transmission may be confined within a gNB FFP and before an idle period of the gNB FFP. For instance, the interval of the UL transmission may be confined within a duration expressed as [gNB_FFP_start+Δ, gNB_idle_period_start], where: (i) gNB_FFP_start denotes a start time of the gNB FFP, (ii) gNB_idle_period_start denotes a start time of the idle period of the gNB FFP, and (iii) A denotes a time duration of a UE processing time.

In some implementations, processor 212 may perform additional operations. For instance, processor 212 may receive, via transceiver 216, a cancellation signal from the network node during the COT. Moreover, processor 212 may cancel, in response to receiving the cancellation signal, the COT as an ongoing UE-initiated COT.

In some implementations, processor 212 may also transmit, via transceiver 216, to the network node an acknowledgement of reception of the cancellation signal.

In some implementations, processor 212 may further transmit, via transceiver 216, to the network node an indication of support of cancellation of an ongoing UE-initiated COT prior to receiving the cancellation signal, with the support of the cancellation being a feature of a UE capability.

In some implementations, processor 212 may also receive, via transceiver 216, from the network node an RRC signal configuring the feature of the UE capability.

In some implementations, processor 212 may further receive, via transceiver 216, from the network node a signal configuring a time instant at which the UE cancels the ongoing UE-initiated COT. In some implementations, in receiving the signal, processor 212 may semi-statically receive an RRC signal or dynamically receive a DCI signal. In some implementations, the time instant may include a start boundary of a gNB FFP or a start boundary of a FFP of another UE.

Under various proposed schemes pertaining to gNB and UE COT sharing in mobile communications in accordance with the present disclosure, with communication apparatus 210 implemented in or as UE 110 and network apparatus 220 implemented in or as network node 125 in network environment 100, processor 212 of communication apparatus 210 may receive, via transceiver 216, a cancellation signal from a network node of a wireless network (e.g., apparatus 220 as network node 125 of wireless network 120) during an ongoing UE-initiated COT. Moreover, processor 212 may cancel, in response to receiving the cancellation signal, the ongoing UE-initiated COT.

In some implementations, processor 212 may also transmit, via transceiver 216, to the network node an acknowledgement of reception of the cancellation signal.

In some implementations, processor 212 may further transmit, via transceiver 216, to the network node an indication of support of cancellation of the ongoing UE-initiated COT prior to receiving the cancellation signal, with the support of the cancellation being a feature of a UE capability.

In some implementations, processor 212 may also receive, via transceiver 216, from the network node an RRC signal configuring the feature of the UE capability.

In some implementations, processor 212 may further receive, via transceiver 216, from the network node a signal configuring a time instant at which the UE cancels the ongoing UE-initiated COT. In some implementations, in receiving the signal, processor 212 may semi-statically receive an RRC signal or dynamically receive a DCI signal. In some implementations, the time instant may include a start boundary of a gNB FFP or a start boundary of a FFP of another UE.

### Illustrative Processes

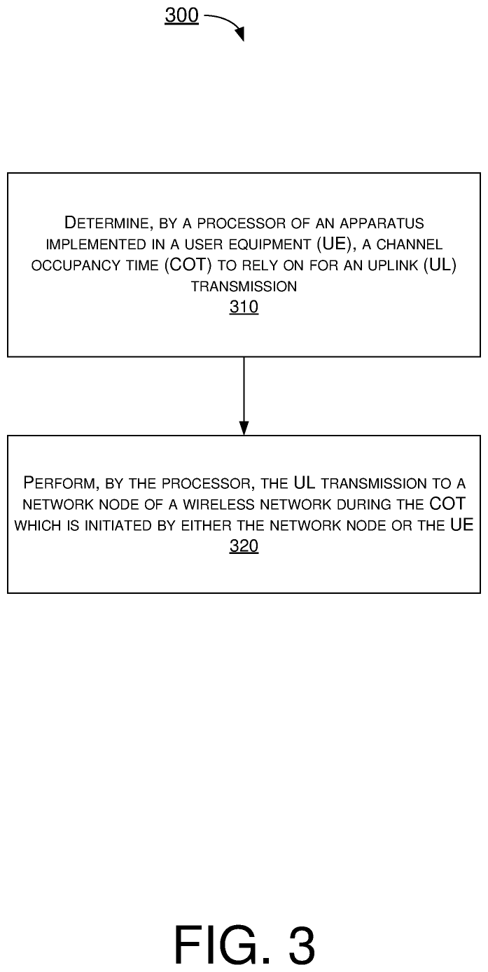

FIG. 3 illustrates an example process 300 in accordance with an implementation of the present disclosure. Process 300 may be an example implementation of schemes described above whether partially or completely, with respect to gNB and UE COT sharing in mobile communications in accordance with the present disclosure. Process 300 may represent an aspect of implementation of features of communication apparatus 210 and network apparatus 220. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices as well as by and network apparatus 220 or any suitable network node or base station. Solely for illustrative purposes and without limitation, process 300 is described below in the context of communication apparatus 210 implemented in or as UE 110 and network apparatus 220 implemented in or as network node 125. Process 300 may begin at block 310.

At 310, process 300 may involve processor 212 of communication apparatus 210, implemented in or as UE 110, determining a COT to rely on for an UL transmission. Process 300 may proceed from 310 to 320.

At 320, process 300 may involve processor 212 performing, via transceiver 216, the UL transmission to a network node of a wireless network (e.g., apparatus 220 as network node 125 of wireless network 120) during the COT, which may be initiated by either the network node or the UE (e.g., the COT being either a gNB-initiated COT or a UE-initiated COT).

In some implementations, in determining the COT, process 300 may involve processor 212 being dynamically configured by the network node by: (a) receiving, via transceiver 216, a DCI signal from the network node; and (b) determining whether the COT is initiated by the UE or by the network node (e.g., gNB) based on the DCI signal.

In some implementations, in determining the COT, process 300 may involve processor 212 being semi-statically configured by the network node by: (a) receiving, via transceiver 216, an RRC signal from the network node; and (b) determining whether the COT is initiated by the UE or by the network node (e.g., gNB) based on the RRC signal.

In some implementations, an interval of the UL transmission may be confined within a gNB FFP and before an idle period of the gNB FFP. For instance, the interval of the UL transmission may be confined within a duration expressed as [gNB_FFP_start+Δ, gNB_idle_period_start], where: (i) gNB_FFP_start denotes a start time of the gNB FFP, (ii) gNB_idle_period_start denotes a start time of the idle period of the gNB FFP, and (iii) A denotes a time duration of a UE processing time.

In some implementations, process 300 may involve processor 212 performing additional operations. For instance, process 300 may involve processor 212 receiving, via transceiver 216, a cancellation signal from the network node during the COT. Moreover, process 300 may involve processor 212 cancelling, in response to receiving the cancellation signal, the COT as an ongoing UE-initiated COT.

In some implementations, process 300 may further involve processor 212 transmitting, via transceiver 216, to the network node an acknowledgement of reception of the cancellation signal.

In some implementations, process 300 may further involve processor 212 transmitting, via transceiver 216, to the network node an indication of support of cancellation of an ongoing UE-initiated COT prior to receiving the cancellation signal, with the support of the cancellation being a feature of a UE capability.

In some implementations, process 300 may further involve processor 212 receiving, via transceiver 216, from the network node an RRC signal configuring the feature of the UE capability.

In some implementations, process 300 may further involve processor 212 receiving, via transceiver 216, from the network node a signal configuring a time instant at which the UE cancels the ongoing UE-initiated COT. In some implementations, in receiving the signal, process 300 may involve processor 212 semi-statically receiving an RRC signal or dynamically receiving a DCI signal. In some implementations, the time instant may include a start boundary of a gNB FFP or a start boundary of a FFP of another UE.

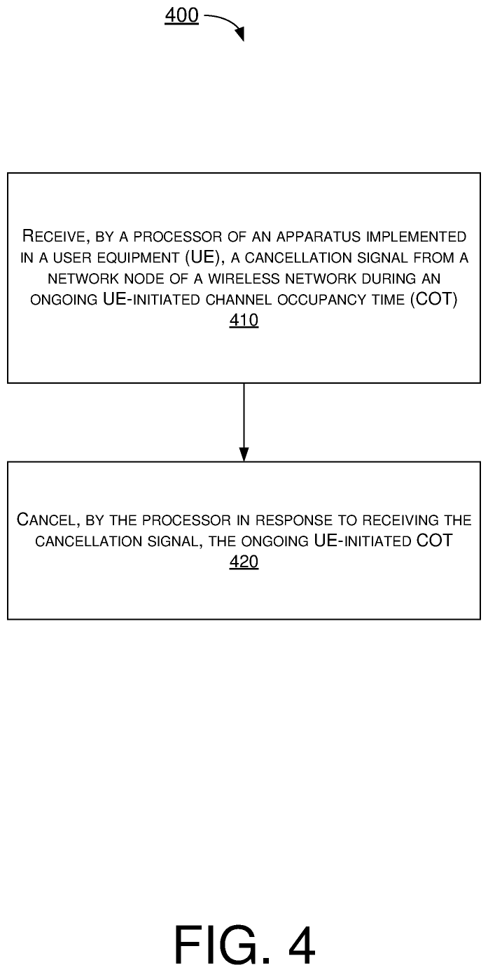

FIG. 4 illustrates an example process 400 in accordance with an implementation of the present disclosure. Process 400 may be an example implementation of schemes described above whether partially or completely, with respect to gNB and UE COT sharing in mobile communications in accordance with the present disclosure. Process 400 may represent an aspect of implementation of features of communication apparatus 210 and network apparatus 220. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices as well as by and network apparatus 220 or any suitable network node or base station. Solely for illustrative purposes and without limitation, process 400 is described below in the context of communication apparatus 210 implemented in or as UE 110 and network apparatus 220 implemented in or as network node 125. Process 400 may begin at block 410.

At 410, process 400 may involve processor 212 of communication apparatus 210, implemented in or as UE 110, receiving, via transceiver 216, a cancellation signal from a network node of a wireless network (e.g., apparatus 220 as network node 125 of wireless network 120) during an ongoing UE-initiated COT. Process 400 may proceed from 410 to 420.

At 420, process 400 may involve processor 212 cancelling, in response to receiving the cancellation signal, the ongoing UE-initiated COT.

In some implementations, process 400 may further involve processor 212 transmitting, via transceiver 216, to the network node an acknowledgement of reception of the cancellation signal.

In some implementations, process 400 may further involve processor 212 transmitting, via transceiver 216, to the network node an indication of support of cancellation of the ongoing UE-initiated COT prior to receiving the cancellation signal, with the support of the cancellation being a feature of a UE capability.

In some implementations, process 400 may further involve processor 212 receiving, via transceiver 216, from the network node an RRC signal configuring the feature of the UE capability.

In some implementations, process 400 may further involve processor 212 receiving, via transceiver 216, from the network node a signal configuring a time instant at which the UE cancels the ongoing UE-initiated COT. In some implementations, in receiving the signal, process 400 may involve processor 212 semi-statically receiving an RRC signal or dynamically receiving a DCI signal. In some implementations, the time instant may include a start boundary of a gNB FFP or a start boundary of a FFP of another UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus implemented in a user equipment (UE), a channel occupancy time (COT) to rely on for an uplink (UL) transmission; and
performing, by the processor, the UL transmission to a network node of a wireless network during the COT,
wherein the COT is initiated by either the network node or the UE.

2. The method of claim 1, wherein the determining of the COT comprises dynamically configured by the network node by:
receiving a downlink control information (DCI) signal from the network node; and
determining whether the COT is initiated by the UE or by the network node based on the DCI signal.

3. The method of claim 1, wherein the determining of the COT comprises semi-statically configured by the network node by:
receiving a radio resource control (RRC) signal from the network node; and
determining whether the COT is initiated by the UE or by the network node based on the RRC signal.

4. The method of claim 1, wherein an interval of the UL transmission is confined within a network node (gNB) fixed frame period (FFP) and before an idle period of the gNB FFP.

5. The method of claim 4, wherein the interval of the UL transmission is confined within a duration expressed as [gNB_FFP_start+Δ, gNB_idle_period_start], and wherein:
gNB_FFP_start denotes a start time of the gNB FFP,
gNB_idle_period_start denotes a start time of the idle period of the gNB FFP, and
Δ denotes a time duration of a UE processing time.

6. The method of claim 1, further comprising:
receiving, by the processor, a cancellation signal from the network node during the COT; and
cancelling, by the processor in response to receiving the cancellation signal, the COT as an ongoing UE-initiated COT.

7. The method of claim 6, further comprising:
transmitting, by the processor, to the network node an acknowledgement of reception of the cancellation signal.

8. The method of claim 6, further comprising:
transmitting, by the processor, to the network node an indication of support of cancellation of an ongoing UE-initiated COT prior to receiving the cancellation signal,
wherein the support of the cancellation is a feature of a UE capability.

9. The method of claim 8, further comprising:
receiving, by the processor, from the network node a radio resource control (RRC) signal configuring the feature of the UE capability.

10. The method of claim 6, further comprising:
receiving, by the processor, from the network node a signal configuring a time instant at which the UE cancels the ongoing UE-initiated COT.

11. The method of claim 10, wherein the receiving of the signal comprises semi-statically receiving a radio resource control (RRC) signal or dynamically receiving a downlink control information (DCI) signal.

12. The method of claim 10, wherein the time instant comprises a start boundary of a network node (gNB) fixed frame period (FFP) or a start boundary of a FFP of another UE.

13. A method, comprising:
receiving, by a processor of an apparatus implemented in a user equipment (UE), a cancellation signal from a network node of a wireless network during an ongoing UE-initiated channel occupancy time (COT); and
cancelling, by the processor in response to receiving the cancellation signal, the ongoing UE-initiated COT.

14. The method of claim 13, further comprising:
transmitting, by the processor, to the network node an acknowledgement of reception of the cancellation signal.

15. The method of claim 13, further comprising:
transmitting, by the processor, to the network node an indication of support of cancellation of the ongoing UE-initiated COT prior to receiving the cancellation signal,
wherein the support of the cancellation is a feature of a UE capability.

16. The method of claim 15, further comprising:
receiving, by the processor, from the network node a radio resource control (RRC) signal configuring the feature of the UE capability.

17. The method of claim 13, further comprising:
receiving, by the processor, from the network node a signal configuring a time instant at which the UE cancels the ongoing UE-initiated COT.

18. The method of claim 17, wherein the receiving of the signal comprises semi-statically receiving a radio resource control (RRC) signal or dynamically receiving a downlink control information (DCI) signal.

19. The method of claim 17, wherein the time instant comprises a start boundary of a network node (gNB) fixed frame period (FFP) or a start boundary of a FFP of another UE.

20. An apparatus implementable in a user equipment (UE), comprising:
a transceiver configured to communicate wirelessly; and
a processor coupled to the transceiver and configured to perform operations comprising:
receiving, via the transceiver, a downlink control information (DCI) signal from a network node of a wireless network;
determining, based on the DCI signal, a channel occupancy time (COT) which is initiated by either the network node or the UE; and
performing, via the transceiver, an uplink (UL) transmission to the network node during the COT.
